(19) United States
(12) Patent Application Publication
(10) Pub. No.: US 2026/0331725 A1
(43) Pub. Date: Oct. 22, 2026

(54) SECONDARY BATTERY AND ELECTRONIC DEVICE

(71) Applicant: Ningde Amperex Technology Limited, Ningde (CN)

(72) Inventors: Feifei LV, Ningde (CN); Hua WU, Ningde (CN)

(73) Assignee: Ningde Amperex Technology Limited, Ningde (CN)

(21) Appl. No.: 19/654,512

(22) Filed: Apr. 22, 2026

(30) Foreign Application Priority Data
Apr. 22, 2025 (CN) 202510506561.7

(51) Int. Cl. H01M 50/552; H01M 50/172; H01M 50/528; H01M 50/531; H01M 50/566

(52) U.S. Cl. CPC H01M 50/552; H01M 50/172; H01M 50/528; H01M 50/531; H01M 50/566

(57) ABSTRACT

A secondary battery includes an electrode assembly enclosed within a housing formed by a first and a second packaging portion arranged opposite each other to define a space to accommodate the electrode assembly. The electrode assembly contains an electrode plate with a current collector. A plurality of protruding tabs are provided on one side of the current collector. Along the thickness direction of the battery, some of these tabs overlap and converge to form a connecting portion. This connecting portion consists of a first connecting section, a bent section, and a second connecting section. The bent section links the first and second sections and is bent along the battery's thickness direction, positioned near the first packaging portion. An electrode assembly fixing adhesive is provided between the electrode assembly and the first packaging portion, and is configured to bond the electrode assembly to the first packaging portion.

### CROSS-REFERENCE TO RELATED APPLICATION

The present application claims priority to Chinese Patent Application No. 202510506561.7, filed on Apr. 22, 2025, the disclosure of which is hereby incorporated by reference in its entirety.

### TECHNICAL FIELD

This application relates to the field of electrochemical technology, and in particular, to a secondary battery and an electronic device.

### BACKGROUND

During manufacturing and long-term use of a secondary battery, drop safety is critical. When an electrode assembly with a plurality of electrode plate layers is subjected to a drop, the electrode assembly may shift or deform. This may lead to internal structural damage of the electrode assembly, electrolyte leakage, short-circuiting, or even fire and explosion.

### SUMMARY

An objective of this application is to provide a secondary battery and an electronic device to reduce the risk of displacement or deformation of an electrode assembly during a drop. Specific technical solutions are as follows:

A first aspect of this application provides a secondary battery. The secondary battery includes an electrode assembly and a housing. The housing includes a first packaging portion and a second packaging portion. The first packaging portion and the second packaging portion are disposed opposite to each other and cooperatively define an accommodation space to accommodate the electrode assembly. The electrode assembly includes an electrode plate. The electrode plate includes a current collector. A plurality of protruding tabs are provided on one side of the current collector. Along a thickness direction of the battery, at least a part of the plurality of tabs overlap and converge to form a connecting portion. The connecting portion includes a first connecting section, a bent section, and a second connecting section. The bent section is connected to the first connecting section and the second connecting section. The bent section is bent along a first direction and is close to the first packaging portion, the first direction being the thickness direction of the secondary battery. The secondary battery further includes a transition piece. The transition piece is connected to the second connecting section. A part of the transition piece extends out of the housing. An electrode assembly fixing adhesive is provided between the electrode assembly and the first packaging portion, and is configured to bond the electrode assembly to the first packaging portion. The bent section is a bent part of the connecting portion, and the electrode assembly fixing adhesive connects the first packaging portion and the electrode assembly. By providing the electrode assembly fixing adhesive, and by setting the electrode assembly fixing adhesive to be relatively thin, this application enables firmer connection between the electrode assembly and the housing while ensuring a sufficient energy density, thereby reducing internal displacement and deformation during a drop and improving the overall structural stability of the battery cell. When the secondary battery is subjected to a drop, the electrode assembly drives the connecting portion to move synchronously, thereby reducing the displacement of the tabs relative to the electrode assembly, lowering the risk of tab squeezing, and improving the stress condition of the tabs. In addition, after being converged, the tabs form a first connecting section and are then bent, thereby increasing the distance from the tabs to the bent section. This reduces the risk of stress concentration occurring at the bent section of the connecting portion, thereby lowering the risk of fracture of the tabs at the bent portion, and improving the safety performance of the secondary battery.

In an embodiment of this application, a device fixing adhesive is provided on an outer side of the housing, and is configured to fix the secondary battery to a device. The device fixing adhesive is disposed on an outer side of the second packaging portion. The electrode assembly fixing adhesive is applied to the inner side of the first packaging portion. The electrode assembly fixing adhesive and the device fixing adhesive are applied to different sides of the housing. The electrode assembly fixing adhesive connects the first packaging portion and the electrode assembly, and is configured to implement fixation between the electrode assembly and the housing. The device fixing adhesive connects the housing to a device, and is configured to implement fixation between the housing and the device. Because the electrode assembly fixing adhesive and the device fixing adhesive are located on opposite sides of the housing respectively, the interaction force between the electrode assembly and the housing is prevented from being affected by mutual tearing between the housing and the device during a drop of the secondary battery. In other words, the force of the mutual tearing between the housing and the device is prevented from being transmitted to the electrode assembly fixing adhesive through the housing. Therefore, this arrangement reduces the risk of damage to the electrode plate connected to the electrode assembly fixing adhesive due to concentrated force during a drop of the secondary battery, thereby improving the safety performance of the secondary battery.

In an embodiment of this application, the transition piece includes a first section and a second section. The first section is connected to the second connecting section. An angle between the first section and the second section is 60° to 150°. The transition piece is welded to the second connecting section, thereby increasing the mechanical strength of the connection between the connecting portion and the transition piece, making the connection tighter between the connecting portion and the transition piece, and reducing the risk of detachment of the transition piece from the connecting portion during a drop of the electrode assembly.

In an embodiment of this application, the first connecting section is a straight section. A bend is formed between the first section and the second section of the transition piece. The bend together with the first connecting section and the bent section forms a quasi-T-shaped bend. The T-shaped bend structure exerts a buffer effect during a drop of the electrode assembly, and can reduce the stress on the tabs, thereby reducing the risk of tab fracture. Therefore, this arrangement improves the safety performance of the secondary battery.

In an embodiment of this application, the transition piece includes a third section, a fourth section, a fifth section, and a sixth section. The fourth section is connected to the third section and the fifth section. The third section and the fifth section are spaced apart along a second direction, the second direction being a length direction of the electrode assembly. The fifth section is connected to the sixth section. A part of the sixth section extends out of the housing. The third section is welded to the second connecting section. The transition piece is welded to the connecting portion, thereby increasing the mechanical strength of the connection between the transition piece and the connecting portion, making the connection tighter between the connecting portion and the transition piece, and reducing the risk of detachment of the transition piece from the connecting portion during a drop of the electrode assembly. A bend is formed between the third section and the fourth section of the transition piece, a bend is formed between the fourth section and the fifth section, and a bend is formed between the fifth section and the sixth section. Further, the bend between the third section and the fourth section, together with the first connecting section, the second connecting section, and the bent section of the connecting portion, can form a quasi-W-shaped bend. The plurality of bends exert a stronger buffer effect during a drop of the electrode assembly, reduce the stress on the tabs, and therefore, reduce the risk of tab fracture. Therefore, this arrangement improves the safety performance of the secondary battery.

In an embodiment of this application, a protective adhesive is provided at a welding spot between the second connecting section and the transition piece. The protective adhesive covers the welding spot between the second connecting section and the transition piece. The protective adhesive wraps around the welding spot at least once, thereby effectively wrapping any weld burrs. This reduces the risk of the welding spot puncturing the housing during a subsequent drop of the secondary battery, even if the welding spot comes into contact with the housing. Further, the protective adhesive exerts an insulating effect, and reduces the risk of short-circuiting when the welding spot contacts the electrode assembly. In addition, the protective adhesive makes the connection tighter between the connecting portion and the transition piece, and reduces the risk of detachment of the transition piece from the connecting portion during a drop of the electrode assembly. Therefore, this arrangement improves the safety performance of the secondary battery.

In an embodiment of this application, a distance between the bent section and the electrode assembly is 30% to 60% of a length dimension of the electrode assembly. This arrangement provides a buffer space for the electrode assembly during a drop of the secondary battery, and allows the connecting portion to move with the electrode assembly, thereby reducing the displacement of the tabs relative to the electrode assembly, reducing the risk of stress on the tabs, improving the condition of stress on the tabs during a drop of the electrode assembly, and reducing the risk of tab fracture. Therefore, this arrangement improves the safety performance of the secondary battery.

In an embodiment of this application, the electrode assembly fixing adhesive includes one of an SIS adhesive or a double-sided adhesive. The SIS adhesive is a thermoplastic elastomer that can be used as a hot-melt pressure-sensitive adhesive. The double-sided adhesive is an adhesive layer applied to both sides of a substrate layer. The double-sided adhesive is not particularly limited herein, as long as the objectives of this application can be achieved. With the same bonding strength, the above material is relatively thin, thereby increasing the energy density of the secondary battery.

In an embodiment of this application, a thickness of the electrode assembly fixing adhesive is 12 μm to 35 μm.

In an embodiment of this application, along the first direction, a minimum distance between an outer contour of an orthographic projection of the electrode assembly fixing adhesive and an outer contour of an orthographic projection of each of the plurality of electrode plate layers is 5 mm to 40 mm. The shape of the outer contour of the orthographic projection of the electrode assembly fixing adhesive projected along the first direction is not particularly limited herein, as long as the objectives of this application can be achieved.

By controlling the thickness of the electrode assembly fixing adhesive and the minimum distance between the outer contour of the orthographic projection of the electrode assembly fixing adhesive and the outer contour of the orthographic projection of each of the plurality of electrode plate layers to fall within the ranges specified herein, this application increases the bonding strength of the electrode assembly fixing adhesive. This allows the connecting portion to move with the electrode assembly during a drop of the secondary battery, thereby reducing the displacement of the tabs relative to the electrode assembly, reducing the risk of stress on the tabs, improving the condition of stress on the tabs during a drop of the electrode assembly, and reducing the risk of tab fracture. Therefore, this arrangement improves the safety performance of the secondary battery.

A second aspect of this application provides an electronic device. The electronic device includes the secondary battery disclosed in any one of the preceding embodiments. Therefore, the electronic device provided in this application exhibits good safety performance.

Some of the beneficial effects of this application are as follows:

This application provides a secondary battery and an electronic device. The secondary battery includes an electrode assembly and a housing. The housing includes a first packaging portion and a second packaging portion. The first packaging portion and the second packaging portion are disposed opposite to each other and cooperatively define an accommodation space to accommodate the electrode assembly. The electrode assembly includes an electrode plate. The electrode plate includes a current collector. A plurality of protruding tabs are provided on one side of the current collector. Along a thickness direction of the battery, at least a part of the plurality of tabs overlap and converge to form a connecting portion. The connecting portion includes a first connecting section, a bent section, and a second connecting section. The bent section is connected to the first connecting section and the second connecting section. The bent section is bent along a first direction and is close to the first packaging portion, the first direction being the thickness direction of the secondary battery. The secondary battery further includes a transition piece. The transition piece is connected to the second connecting section. A part of the transition piece extends out of the housing. An electrode assembly fixing adhesive is provided between the electrode assembly and the first packaging portion, and is configured to bond the electrode assembly to the first packaging portion. The bent section is a bent part of the connecting portion, and the electrode assembly fixing adhesive connects the first packaging portion and the electrode assembly. By providing the electrode assembly fixing adhesive, and by setting the electrode assembly fixing adhesive to be relatively thin, this application enables firmer connection between the electrode assembly and the housing while ensuring a sufficient energy density, thereby reducing internal displacement and deformation during a drop and improving the overall structural stability of the battery cell. When the secondary battery is subjected to a drop, the electrode assembly drives the connecting portion to move synchronously, thereby reducing the displacement of the tabs relative to the electrode assembly, lowering the risk of tab squeezing, and improving the stress condition of the tabs. In addition, after being converged, the tabs form a first connecting section and are then bent, thereby increasing the distance from the tabs to the bent section. This reduces the risk of stress concentration occurring at the bent section of the connecting portion, thereby lowering the risk of fracture of the tabs at the bent portion, and improving the safety performance of the secondary battery.

Definitely, a single product or method in which the technical solution of this application is implemented does not necessarily achieve all of the above advantages concurrently.

### BRIEF DESCRIPTION

To describe the technical solutions in some embodiments of this application more clearly, the following outlines the drawings to be used in the description of the embodiments. Evidently, the drawings outlined below merely illustrate some embodiments of this application, and a person of ordinary skill in the art may derive other embodiments based on the drawings.

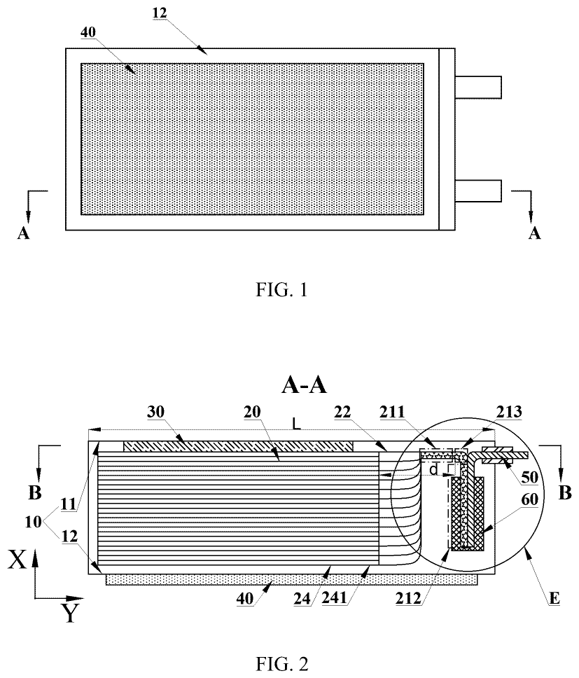

FIG. 1 is a schematic structural diagram of a secondary battery according to an embodiment of this application;

FIG. 2 is a cross-sectional view of sectioning along an A-A line shown in FIG. 1;

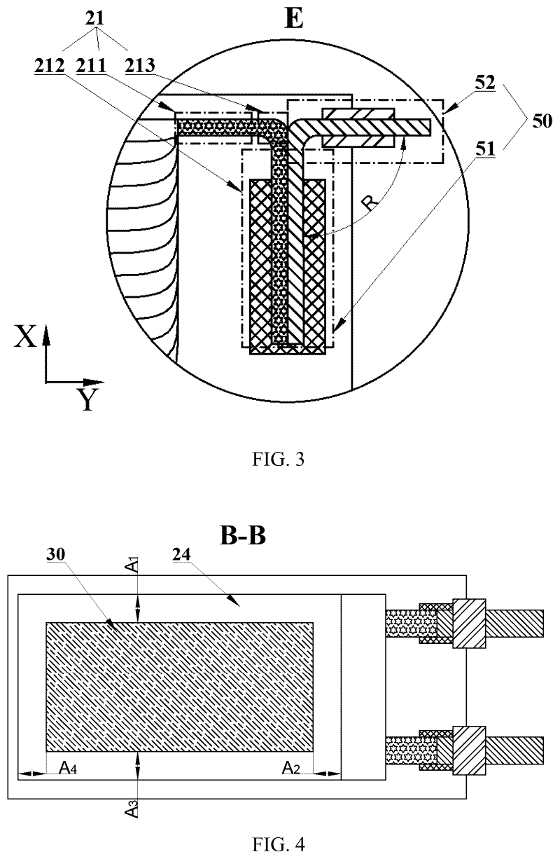

FIG. 3 is a close-up view of a part E shown in FIG. 2;

FIG. 4 is a cross-sectional view of sectioning along a B-B line shown in FIG. 2;

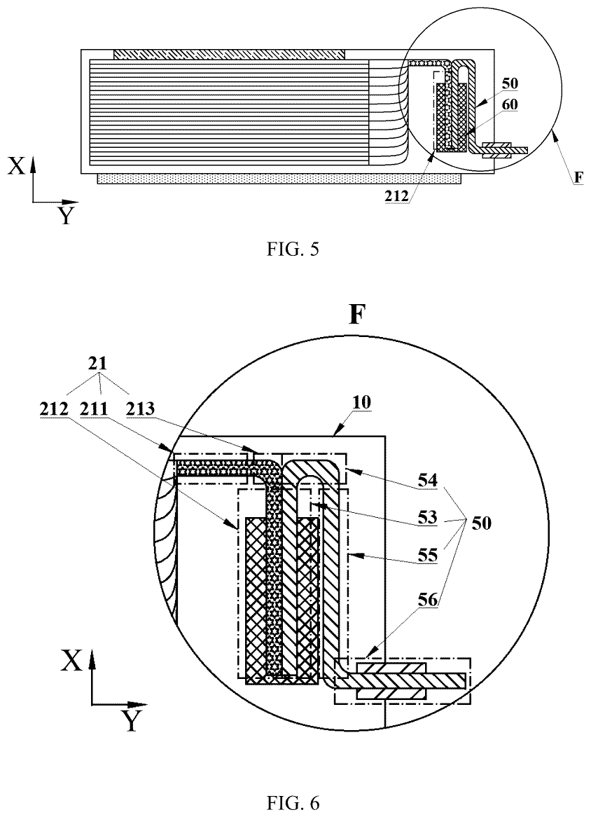

FIG. 5 is a schematic structural diagram of an electrode assembly of a secondary battery according to another embodiment of this application; and

FIG. 6 is a close-up view of a part F shown in FIG. 5.

### LIST OF REFERENCE SIGNS

housing 10; first packaging portion 11; second packaging portion 12; electrode assembly 20; connecting portion 21; first connecting section 211; second connecting section 212; bent section 213; tab 22; electrode plate 24; current collector 241; electrode assembly fixing adhesive 30; device fixing adhesive 40; transition piece 50; first section 51; second section 52; third section 53; fourth section 54; fifth section 55; sixth section 56; protective adhesive 60.

### DETAILED DESCRIPTION

The following describes the technical solutions in this application clearly and comprehensively with reference to the embodiments and accompanying drawings hereof. Evidently, the described embodiments are merely a part of but not all of the embodiments of this application. All other embodiments derived by a person skilled in the art based on this application still fall within the protection scope of this application.

An objective of this application is to provide a secondary battery and an electronic device to reduce the risk of displacement or deformation of an electrode assembly during a drop. Specific technical solutions are as follows:

A first aspect of this application provides a secondary battery. As shown in FIG. 2, the secondary battery includes an electrode assembly 20 and a housing 10. The housing 10 includes a first packaging portion 11 and a second packaging portion 12. The first packaging portion 11 and the second packaging portion 12 are disposed opposite to each other and cooperatively define an accommodation space to accommodate the electrode assembly 20. The electrode assembly 20 includes an electrode plate 24. The electrode plate 24 includes a current collector 241. A plurality of protruding tabs 22 are provided on one side of the current collector 241. Along a thickness direction (X direction) of the battery, at least a part of the plurality of tabs 22 overlap and converge to form a connecting portion 21. As shown in FIG. 3, the connecting portion 21 includes a first connecting section 211 and a second connecting section 212. A bent section 213 is connected to the first connecting section 211 and the second connecting section 212. The first connecting section 211 extends from a start point of the overlapping part of the plurality of tabs 22 to a start point of the bent section 213. The bent section 213 is bent along a first direction (X direction) and is close to the first packaging portion 11, the first direction (X direction) being the thickness direction (X direction) of the secondary battery. The secondary battery further includes a transition piece 50. The transition piece 50 is connected to the second connecting section 212. A part of the transition piece 50 extends out of the housing 10. An electrode assembly fixing adhesive 30 is provided between the electrode assembly 20 and the first packaging portion 11, and is configured to bond the electrode assembly 20 to the first packaging portion 11. The bent section 213 is a bent part of the connecting portion 21, and the electrode assembly fixing adhesive 30 connects the first packaging portion 11 and the electrode assembly 20. By providing the electrode assembly fixing adhesive, and by setting the electrode assembly fixing adhesive to be relatively thin, this application enables firmer connection between the electrode assembly and the housing while ensuring a sufficient energy density, thereby reducing internal displacement and deformation during a drop and improving the overall structural stability of the battery cell. When the secondary battery is subjected to a drop, the electrode assembly drives the connecting portion to move synchronously, thereby reducing the displacement of the tabs relative to the electrode assembly, lowering the risk of tab squeezing, and improving the stress condition of the tabs. In addition, after being converged, the tabs form a first connecting section and are then bent, thereby increasing the distance from the tabs to the bent section. This reduces the risk of stress concentration occurring at the bent section of the connecting portion, thereby lowering the risk of fracture of the tabs at the bent portion, and improving the safety performance of the secondary battery.

In an embodiment of this application, as shown in FIG. 1, a device fixing adhesive 40 is provided on the outer side of the housing 10, and is configured to fix the secondary battery to a device. The device fixing adhesive 40 is disposed on the outer side of the second packaging portion 12. As shown in FIG. 2, the electrode assembly fixing adhesive 30 is applied to the inner side of the first packaging portion 11. The electrode assembly fixing adhesive 30 and the device fixing adhesive 40 are applied to different sides of the housing 10. The electrode assembly fixing adhesive 30 connects the first packaging portion 11 and the electrode assembly 20, and is configured to implement fixation between the housing 10 and the electrode assembly 20. The device fixing adhesive 40 connects the housing 10 to a device, and is configured to implement fixation between the housing 10 and the device. Because the electrode assembly fixing adhesive 30 and the device fixing adhesive 40 are located on opposite sides of the housing 10 respectively, the interaction force between the electrode assembly 20 and the housing 10 is prevented from being affected by mutual tearing between the housing 10 and the device during a drop of the secondary battery. In other words, the force of the mutual tearing between the housing 10 and the device is prevented from being transmitted to the electrode assembly fixing adhesive 30 through the housing 10. Therefore, this arrangement reduces the risk of damage to the electrode plate connected to the electrode assembly fixing adhesive due to concentrated force during a drop of the secondary battery, thereby improving the safety performance of the secondary battery. The device is not particularly limited herein, as long as the objectives of this application can be achieved. The device fixing adhesive is not particularly limited herein, as long as the objectives of this application can be achieved. For example, the device fixing adhesive may be easy-to-pull adhesive or double-sided adhesive.

In an embodiment of this application, as shown in FIG. 3, the transition piece 50 includes a first section 51 and a second section 52. The first section 51 is welded to the second connecting section 212. An angle R between the first section 51 and the second section 52 is 60° to 150°. For example, the angle between the first section and the second section may be 60°, 70°, 80°, 90°, 100°, 110°, 120°, 130°, 140°, 150°, or a value falling within a range formed by any two thereof. The transition piece 50 is welded to the second connecting section 212, thereby increasing the mechanical strength of the connection between the connecting portion 21 and the transition piece 50, making the connection tighter between the connecting portion 21 and the transition piece 50, and reducing the risk of detachment of the transition piece from the connecting portion during a drop of the electrode assembly.

In an embodiment of this application, as shown in FIG. 3, the first connecting section 211 is a straight section. A bend is formed between the first section 51 and the second section 52 of the transition piece 50. The bend together with the first connecting section 211 and the bent section 213 forms a quasi-T-shaped bend. The T-shaped bend structure exerts a buffer effect during a drop of the electrode assembly, and can reduce the stress on the tabs, thereby reducing the risk of tab fracture. Therefore, this arrangement improves the safety performance of the secondary battery.

In an embodiment of this application, as shown in FIG. 6, the transition piece 50 includes a third section 53, a fourth section 54, a fifth section 55, and a sixth section 56. The fourth section 54 is connected to the third section 53 and the fifth section 55. The third section 53 and the fifth section 55 are spaced apart along a second direction (Y direction). The fifth section 55 is connected to the sixth section 56. A part of the sixth section 56 extends out of the housing 10. The third section 53 is welded to the second connecting section 212. The transition piece 50 is welded to the connecting portion 21, thereby increasing the mechanical strength of the connection between the transition piece and the connecting portion, making the connection tighter between the connecting portion and the transition piece, and reducing the risk of detachment of the transition piece from the connecting portion during a drop of the electrode assembly. A bend is formed between the third section 53 and the fourth section 54 of the transition piece 50, a bend is formed between the fourth section 54 and the fifth section 55, and a bend is formed between the fifth section 55 and the sixth section 56. Further, the bend between the third section 53 and the fourth section 54, together with the first connecting section 211, the second connecting section 212, and the bent section 213 of the connecting portion 21, can form a quasi-W-shaped bend. The plurality of bends exert a stronger buffer effect during a drop of the electrode assembly, reduce the stress on the tabs, and therefore, reduce the risk of tab fracture. Therefore, this arrangement improves the safety performance of the secondary battery.

In an embodiment of this application, as shown in FIG. 2 and FIG. 5, a protective adhesive 60 is provided at a welding spot between the second connecting section 212 and the transition piece 50. The protective adhesive 60 covers the welding spot between the second connecting section 212 and the transition piece 50. The protective adhesive wraps around the welding spot at least once, thereby effectively wrapping any weld burrs. This reduces the risk of the welding spot puncturing the housing during a subsequent drop of the secondary battery, even if the welding spot comes into contact with the housing. Further, the protective adhesive exerts an insulating effect, and reduces the risk of short-circuiting when the welding spot contacts the electrode assembly. In addition, the protective adhesive makes the connection tighter between the connecting portion and the transition piece, and reduces the risk of detachment of the transition piece from the connecting portion during a drop of the electrode assembly. Therefore, this arrangement improves the safety performance of the secondary battery.

In an embodiment of this application, a distance between the bent section and the electrode assembly is 30% to 60% of a length dimension of the electrode assembly. For example, a ratio of the distance between the bent section and the electrode assembly to the length dimension of the electrode assembly may be 30%, 40%, 50%, 60%, or a value falling within a range formed by any two thereof. As shown in FIG. 2, the distance between the bent section 213 and the electrode assembly 20 is indicated by d in the figure, and the length dimension (Y direction) of the electrode assembly 20 is indicated by L in the figure. This arrangement provides a buffer space for the electrode assembly during a drop of the secondary battery, and allows the connecting portion to move with the electrode assembly, thereby reducing the displacement of the tabs relative to the electrode assembly, reducing the risk of stress on the tabs, improving the condition of stress on the tabs during a drop of the electrode assembly, and reducing the risk of tab fracture. Therefore, this arrangement improves the safety performance of the secondary battery.

In an embodiment of this application, the electrode assembly fixing adhesive includes one of an SIS adhesive or a double-sided adhesive. The SIS adhesive is a thermoplastic elastomer that can be used as a hot-melt pressure-sensitive adhesive. The double-sided adhesive is an adhesive layer applied to both sides of a substrate layer. The double-sided adhesive is not particularly limited herein, as long as the objectives of this application can be achieved. With the same bonding strength, the above material is relatively thin, thereby increasing the energy density of the secondary battery.

In an embodiment of this application, a thickness of the electrode assembly fixing adhesive is 12 μm to 35 μm. For example, the thickness of the electrode assembly fixing adhesive may be 12 μm, 15 μm, 20 μm, 25 μm, 30 μm, 35 μm, or a value falling within a range formed by any two thereof.

In an embodiment of this application, along the first direction, a minimum distance between an outer contour of an orthographic projection of the electrode assembly fixing adhesive and an outer contour of an orthographic projection of each of the plurality of electrode plate layers is 5 mm to 40 mm. For example, a minimum distance between the outer contour of the orthographic projection of the electrode assembly fixing adhesive and the outer contour of the orthographic projection of each of the plurality of electrode plate layers may be 5 mm, 10 mm, 15 mm, 20 mm, 25 mm, 30 mm, 35 mm, 40 mm, or a value falling within a range formed by any two thereof. The shape of the outer contour of the orthographic projection of the electrode assembly fixing adhesive projected along the first direction is not particularly limited herein, as long as the objectives of this application can be achieved. Illustratively, in an example in which the outer contour of the orthographic projection of the electrode assembly fixing adhesive along the first direction is a rectangle, as shown in FIG. 4, the distances between the outer contour of the orthographic projection of the electrode assembly fixing adhesive 30 and the outer contours of the orthographic projections of the plurality of electrode plate layers 24 are A₁, A₂, A₃, and A₄, respectively.

By controlling the thickness of the electrode assembly fixing adhesive and the minimum distance between the outer contour of the orthographic projection of the electrode assembly fixing adhesive and the outer contour of the orthographic projection of each of the plurality of electrode plate layers to fall within the ranges specified herein, this application increases the bonding strength of the electrode assembly fixing adhesive. This allows the connecting portion to move with the electrode assembly during a drop of the secondary battery, thereby reducing the displacement of the tabs relative to the electrode assembly, reducing the risk of stress on the tabs, improving the condition of stress on the tabs during a drop of the electrode assembly, and reducing the risk of tab fracture. Therefore, this arrangement improves the safety performance of the secondary battery.

The secondary battery is not particularly limited herein, and may be any secondary battery well-known in the art, such as a lithium-ion battery.

The electrode assembly is not particularly limited herein, and may be any electrode assembly well-known in the art, such as a stacked-type electrode assembly or a jelly-roll electrode assembly.

The housing is configured to accommodate a positive electrode plate, a separator, a negative electrode plate, an electrolyte solution, and other components known in the field of secondary batteries. The other components are not limited herein. The housing is not particularly limited herein, and may be a housing well-known in the art, as long as the objectives of this application can be achieved. For example, the housing may be a hard housing or a flexible housing. The material of the hard housing may be metal. The type of the metal is not limited herein. The hard housing may be a metallic hard housing known in the art as long as the objectives of this application can be achieved. The flexible housing may be a metallic laminated film such as an aluminum laminated film, a steel laminated film.

A process of preparing the secondary battery of this application is not particularly limited herein. For example, the preparation process of the secondary battery may include, but is not limited to, the following steps: stacking a positive electrode plate, a separator, and a negative electrode plate in sequence, performing operations as required such as winding and folding on the stacked structure to obtain a jelly-roll electrode assembly, bonding an electrode assembly fixing adhesive to the electrode assembly, placing the electrode assembly into a housing, bonding the electrode assembly fixing adhesive to the first packaging portion, injecting an electrolyte solution into the housing, and sealing the housing to obtain a secondary battery. Alternatively, the preparation process includes: stacking a positive electrode plate, a separator, and a negative electrode plate in sequence, and then fixing the four corners of the entire stacked structure by use of adhesive tape to obtain a stacked-type electrode assembly, bonding an electrode assembly fixing adhesive to the electrode assembly, placing the electrode assembly into a housing, bonding the electrode assembly fixing adhesive to the first packaging portion, injecting an electrolyte solution into the housing, and sealing the housing to obtain a secondary battery. In addition, an overcurrent protection element, a conductive plate, and the like as required may be placed into a housing, so as to prevent the rise of internal pressure, overcharge, and overdischarge of the secondary battery.

A second aspect of this application provides an electronic device. The electronic device includes the secondary battery disclosed in any one of the preceding embodiments. Therefore, the electronic device provided in this application exhibits good safety performance.

The electronic device is not particularly limited herein, and may be any electronic device known in the prior art. For example, the electronic device may include, but is not limited to, a laptop computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, lighting appliance, toy, game console, watch, electric tool, flashlight, camera, large household storage battery, or lithium-ion capacitor.

### EMBODIMENTS

The implementations of this application are described below in more detail with reference to some embodiments and comparative embodiments. Various tests and evaluations are performed by the following methods. In addition, unless otherwise specified, the word “parts” means parts by mass, and the symbol “%” means a percentage by mass.

### Test Methods and Devices

### Test of Tab Fracture Rate and Housing Damage Rate

Using a mobile phone as an example, the test process may be as follows: Connecting a secondary battery to a mobile phone by use of a device fixing adhesive, and performing a drop test on the secondary battery by dropping the mobile phone from a height of 1.5 m above a smooth concrete surface, where the six surfaces of the mobile phone and the four corners of the mobile phone near the secondary battery side hit the concrete surface separately. Testing 100 secondary batteries, and recording the number of secondary batteries with broken tabs or damaged housings after each hitting point of the secondary battery is subjected to 10 drops and 20 drops separately. Calculating the tab fracture rate and the housing damage rate after the 10 drops and the 20 drops separately:

Tab fracture rate=number of secondary batteries with broken tabs/total number of test pieces;

Housing damage rate=number of secondary batteries with damaged housings/total number of test pieces.

### Embodiment 1

### Preparation of a Positive Electrode Plate

Mixing LiCoO₂ as a positive active material, Super P as a conductive agent, and polyvinylidene fluoride as a binder at a mass ratio of 97.9:0.9:1.2, adding N-methyl-pyrrolidone (NMP) as a solvent to formulate a slurry in which the solid content is 75 wt %, and stirring well with a vacuum mixer to obtain a positive electrode slurry. Applying the positive electrode slurry evenly onto one surface of 10 μm-thick positive current collector aluminum foil, and drying the foil at 120° C. to obtain a positive electrode plate coated with a positive electrode material layer on a single side, where the coating weight of the positive electrode material layer is 267.8 mg/1540 mm². Subsequently, repeating the above steps on the other surface of the aluminum foil to obtain a positive electrode plate coated with the positive electrode material layer on both sides. Performing oven-drying at 120° C., and then performing cold-pressing and cutting to form tabs and obtain a positive electrode plate of 74 mm×867 mm in size ready for use. The thickness of the positive electrode material layer on a single side is 42 μm.

### Preparation of a Negative Electrode Plate

Mixing artificial graphite as a negative active material, styrene-butadiene rubber as a binder, and acetylene black as a conductive agent at a mass ratio of 97.4:1.4:1.2, adding deionized water as a solvent to formulate a slurry in which the solid content is 45 wt %, and stirring well with a vacuum mixer to obtain a negative electrode slurry. Applying the negative electrode slurry evenly onto one surface of 6 μm-thick negative current collector copper foil, and drying the foil at 120° C. to obtain a negative electrode plate coated with a negative electrode material layer on a single side, where the coating weight of the negative electrode material layer is 142 mg/1540 mm². Subsequently, repeating the above steps on the other surface of the copper foil to obtain a negative electrode plate coated with the negative electrode material layer on both sides. Drying the electrode plate at 120° C., and then performing cold-pressing and cutting to form tabs and obtain a negative electrode plate of 78 mm×875 mm in size ready for use. The thickness of the negative electrode material layer on a single side is 54.5 μm.

### Preparation of an Electrolyte Solution

Mixing dimethyl carbonate, diethyl carbonate, and ethylene carbonate at a mass ratio of 1:1:1 in an environment in which the water content is less than 10 ppm, and stirring well to obtain an organic solution. Subsequently, adding LiPF₆ as an electrolyte salt into the organic solvent, and stirring well to obtain an electrolyte solution. Based on the mass of the electrolyte solution, the mass percent of the electrolyte salt is 12.5%, and the remainder is the organic solvent.

### Separator

Using a 7 μm-thick porous polyethylene film (supplied by Celgard) as a separator.

### Preparation of a Lithium-Ion Battery

Stacking the above-prepared positive electrode plate, separator, and negative electrode plate in sequence such that the separator is located between the positive electrode plate and the negative electrode plate to serve a function of separation. Winding the stacked plates, and then converging and welding the tabs of a plurality of positive electrode plates to form a positive electrode connecting portion, and converging and welding the tabs of a plurality of negative electrode plates to form a negative electrode connecting portion, so as to obtain an electrode assembly. Placing the electrode assembly into an aluminum laminated film package. Connecting the electrode assembly to the first packaging portion by use of an electrode assembly fixing adhesive such that the bent portions of the positive electrode connecting portion and the negative electrode connecting portion are close to the first packaging portion. Connecting a transition piece to the positive electrode connecting portion and the negative electrode connecting portion separately. Dehydrating the packaged electrode assembly at 80° C., and then injecting the above-prepared electrolyte solution. Performing steps such as vacuum sealing, standing, formation, degassing, and edge trimming to obtain a lithium-ion battery. The upper-limit voltage of the chemical formation is 4.15 V, the temperature of the chemical formation is 70° C., and the chemically formed product is left to stand for 2 hours. Affixing a device fixing adhesive to the outer side of the second packaging portion.

### Embodiment 2

Identical to Embodiment 1 except that the device fixing adhesive is affixed to the outer side of the first packaging portion.

### Comparative Embodiment 1

Identical to Embodiment 1 except that no electrode assembly fixing adhesive is applied.

The performance parameters of each embodiment and each comparative embodiment are shown in Table 1.

TABLE 1

| | 10 drops | | 20 drops | |
|---|---|---|---|---|
| | Tab | Housing | Tab | Housing |
| | fracture rate | damage | fracture rate | damage |
| | (%) | rate (%) | (%) | rate (%) |
| Embodiment 1 | 0 | 0 | 0 | 0 |
| Embodiment 2 | 5 | 6 | 7 | 7 |
| Comparative | 100 | 48 | 100 | 75 |
| Embodiment 1 | | | | |

As can be seen from Embodiments 1 and 2 and Comparative Embodiment 1, by providing an electrode assembly fixing adhesive to the inner side of the first packaging portion of the housing to connect the electrode assembly and the first packaging portion, and by causing the bent section of the connecting portion formed by converging the tabs to be closer to the first packaging portion, this application reduces the risk of tab fracture and housing damage due to displacement or deformation of the electrode assembly during a drop of the electrode assembly. In Comparative Embodiment 1, no electrode assembly fixing adhesive is applied. In Embodiment 2, both the electrode assembly fixing adhesive and the device fixing adhesive are applied to the first packaging portion. In this case, the tab fracture rate and the housing damage rate in Comparative Embodiment 1 are relatively high; and the tab fracture rate and the housing damage rate in Embodiment 1 and Embodiment 2 are relatively low, indicating that the lithium-ion battery exhibits good safety performance.

The embodiments described above are merely preferred embodiments of this application, but are not intended to limit this application. Any and all modifications, equivalent replacements, improvements, and the like made without departing from the concept and principles of this application still fall within the protection scope of this application.

What is claimed is:

1. A secondary battery, comprising an electrode assembly and a housing, wherein the housing comprises a first packaging portion and a second packaging portion, and the first packaging portion and the second packaging portion are disposed opposite to each other and cooperatively define an accommodation space to accommodate the electrode assembly;
the electrode assembly comprises an electrode plate, the electrode plate comprises a current collector, and a plurality of protruding tabs are provided on one side of the current collector;
along a thickness direction of the battery, at least a part of the plurality of tabs overlap and converge to form a connecting portion; the connecting portion comprises a first connecting section, a bent section, and a second connecting section; the bent section is connected to the first connecting section and the second connecting section; and the bent section is bent along a first direction and is closer to the first packaging portion than to the second packaging part, the first direction being the thickness direction of the secondary battery;
the secondary battery further comprises a transition piece, the transition piece is connected to the second connecting section, and a part of the transition piece extends out of the housing; and
an electrode assembly fixing adhesive is provided between the electrode assembly and the first packaging portion, and is configured to bond the electrode assembly to the first packaging portion.

2. The secondary battery according to claim 1, wherein a device fixing adhesive is provided on an outer side of the housing, and is configured to fix the secondary battery to a device, and the device fixing adhesive is disposed on an outer side of the second packaging portion.

3. The secondary battery according to claim 1, wherein the transition piece comprises a first section and a second section, the first section is welded to the second connecting section, the second section extends out of the housing, and an angle between the first section and the second section is 60° to 150°.

4. The secondary battery according to claim 3, wherein the first connecting section is a straight section.

5. The secondary battery according to claim 1, wherein the transition piece comprises a third section, a fourth section, a fifth section, and a sixth section; the fourth section is connected to the third section and the fifth section; the third section and the fifth section are spaced apart along a second direction, the second direction being a length direction of the electrode assembly; the fifth section is connected to the sixth section; and a part of the sixth section extends out of the housing; and the third section is welded to the second connecting section.

6. The secondary battery according to claim 3, wherein a protective adhesive is provided at a welding spot between the second connecting section and the transition piece.

7. The secondary battery according to claim 4, wherein a protective adhesive is provided at a welding spot between the second connecting section and the transition piece.

8. The secondary battery according to claim 5, wherein a protective adhesive is provided at a welding spot between the second connecting section and the transition piece.

9. The secondary battery according to claim 1, wherein a distance between the bent section and the electrode assembly is 30% to 60% of a length dimension of the electrode assembly.

10. The secondary battery according to claim 1, wherein the electrode assembly fixing adhesive comprises one of an SIS adhesive or a double-sided adhesive.

11. The secondary battery according to claim 1, wherein a thickness of the electrode assembly fixing adhesive is 12 μm to 35 μm.

12. The secondary battery according to claim 1, wherein along the first direction, a minimum distance between an outer contour of an orthographic projection of the electrode assembly fixing adhesive and an outer contour of an orthographic projection of each of the plurality of electrode plate layers is 5 mm to 40 mm.

13. An electronic device, comprising the secondary battery according to claim 1.

14. The electronic device according to claim 13, wherein a device fixing adhesive is provided on an outer side of the housing, and fixes the secondary battery to the electronic device, and the device fixing adhesive is disposed on an outer side of the second packaging portion.

15. The electronic device according to claim 13, wherein the transition piece comprises a first section and a second section, the first section is welded to the second connecting section, the second section extends out of the housing, and an angle between the first section and the second section is 60° to 150°.

16. The electronic device according to claim 13, wherein the first connecting section is a straight section.

17. The electronic device according to claim 13, wherein the transition piece comprises a third section, a fourth section, a fifth section, and a sixth section; the fourth section is connected to the third section and the fifth section; the third section and the fifth section are spaced apart along a second direction, the second direction being a length direction of the electrode assembly; the fifth section is connected to the sixth section; and a part of the sixth section extends out of the housing; and the third section is welded to the second connecting section.

18. The electronic device according to claim 17, wherein a protective adhesive is provided at a welding spot between the second connecting section and the transition piece.

19. The electronic device according to claim 13, wherein a distance between the bent section and the electrode assembly is 30% to 60% of a length dimension of the electrode assembly.

20. The electronic device according to claim 13, wherein along the first direction, a minimum distance between an outer contour of an orthographic projection of the electrode assembly fixing adhesive and an outer contour of an orthographic projection of each of the plurality of electrode plate layers is 5 mm to 40 mm.
